(19) United States
(12) Patent Application Publication
(10) Pub. No.: US 2012/0288815 A1
(43) Pub. Date: Nov. 15, 2012

(54) BONDABLE MOLAR TUBE

(76) Inventors: Morton Cohen, Elkins Park, PA (US); Aaron Cohen, Lake Worth, FL (US)

(21) Appl. No.: 13/469,904

(22) Filed: May 11, 2012

Related U.S. Application Data
(60) Provisional application No. 61/484,940, filed on May 11, 2011.

(51) Int. Cl. A61C 7/16

(52) U.S. Cl. 433/9; 433/24

(57) ABSTRACT

An improved bondable molar tube is provided having a base and a tube structure supported on the base, where the base is configured having a first portion that is to be bonded to a mesial cusp of a molar and second portion that is bonded to a distal cusp of the molar, and where the tube structure is provided to be located on the mesial cusp on the first portion of the base, and where the second base portion that is provided on the distal cusp does not have a tube structure thereon and, preferably, is substantially free of structure thereon that may interfere with surrounding teeth.

### BACKGROUND OF THE INVENTION

1. Field of the Invention

The present invention relates to the field of orthodontic appliances for straightening teeth, and more particularly to molar tubes that are used to secure an archwire to a tooth or to other orthodontic appliance components.

2. Brief Description of the Related Art

Orthodontic appliances are used to align teeth to a desired position so that the teeth not only have an attractive appearance, but also properly move and are positioned in a proper alignment that places the teeth is a proper relationship with one another and the patient's physiology so as to reduce wear of the tooth surfaces and prevent or minimize the occurrence of other potential conditions.

Orthodontic treatment began years ago, one of the most notable developments coming from Edward Angle, who in the early 1900's classified certain malocclusions into three categories, malocclusions being the relationship with the molars and the upper and lower teeth to each other. A class I malocclusion, by definition, is when the upper first molar has its mesio-buccal cusp in the groove, the buccal groove of the lower first molar. That is a class I definition of the relationships of the molars. If the molars are in that position, all the other teeth in the arches, upper and lower, may be crowded, and there may also be an overlapping of teeth. So it was this relationship that was defined as a class I malocclusion.

The second category, class II malocclusions is where the mesio-buccal cusp of the upper first molar is not in that lower buccal groove of the first molar, but is one half step forward. All the other teeth, therefore, are forward, and, therefore, the upper front teeth are correspondingly forward. The class II malocclusion also involved the fact that the lower jaw in 25% of these malocclusions really was at fault because it was retrusive or recessive, so that really brought not the upper teeth forward, but it in essence the lower jaw brought all the lower teeth backward. So that created the same situation with the molar relationships, which is called class II. Generally, the class II malocclusion is characterized by the lower dental arch being located excessively rearward relative to the direction of the upper dental arch when the jaws are closed.

A class III malocclusion is where the lower molar and all the teeth anterior, or forward of the lower molar, generally are forward of the upper mesial cusp of the first molar. It is the reverse situation to that of class II. The class III malocclusion is where the lower dental arch is located forwardly from its location relative to the position of the upper dental arch when the jaws are closed.

Treatment of class II and class III malocclusions generally involves the movement of the teeth to orthodontically correct positions. Edward Angle was awarded U.S. Pat. No. 678,453 for a rigid archwire attached to teeth to draw the teeth together. Orthodontists utilize orthodontic appliances, which may, for example, include brackets, buccal tubes, archwires, and other items which are attached to the teeth. Brackets generally have a slot to hold the archwire, and buccal tubes, which are generally attached to the patient's molars, retain the ends of the wire. For example, the archwire may span from a buccal tube attached to a molar, and continue medially to the midline through the brackets attached to each of the teeth of the dental arch, and from the midline, distally to the other end of the dental arch where the archwire is secured to a buccal tube. It is generally common to refer to such orthodontic appliances of the type mentioned collectively, as braces.

One drawback involving the use of orthodontic appliances is that the appliance, such as, tubes, are held to the tooth using adhesive, and, often, the tube may become dislodged from the tooth. When the tube is dislodged, it can be painful for the patient, as the archwire secured to the tube and the tube may dig into the patient's gum. The patient must then visit the orthodontist and have the tube reattached (or a new tube installed) and the archwire reattached, or a new archwire installed. This is time consuming for the patient, and often involves additional expenses for the patient.

A common cause of the dislodgement of tubes, particularly, molar tubes, is the result of occlusions. For example, where a patient is being treated for a Class II malocclusion, as discussed above, where the mesio-buccal cusp of the upper first molar is one half step forward of the lower buccal groove of the first molar, the forward cusp may engage the tube during chewing or when the patient brings the upper and lower jaws together. Over time, the tube may be loosened from the molar to which it is attached and become detached.

A need exists for an improved orthodontic appliance that is more stable and inhibits interference with misaligned teeth or a malocclusion.

### SUMMARY OF THE INVENTION

An improved orthodontic appliance is provided for securing an archwire, where according to a preferred embodiment, an improved bondable molar tube is provided.

It is an object of the present invention to provide an improved bondable molar tube that is configured for attachment to a molar surface and to hold an archwire.

According to one preferred embodiment the improved bondable molar tube is provides with a base having a first side and a second side, with the second side being a mounting side having a textured surface for promoting an adhesive bond of said molar tube to a tooth, a tube structure supported on the base, the tube structure having a mesio-distal end thereof with a slanted configuration, the tube structure including a bore disposed therein extending through the tube structure, and where the tube structure has a gingival length and a body portion, with the body portion having a first tube structure edge and a second tube structure edge, the first tube structure edge being substantially shorter than the second tube structure edge in order to provide the tube structure with a dimension at its gingival length that is relatively longer on one edge of the tube; and a lingual boss for locating and positioning the bondable molar tube on a tooth, the lingual boss extending from the base on said mounting side of the base; and a hook, with the base being configured for attachment to a mesial cusp and a distal cusp of a molar; and with the tube structure being provided in the location of a mesial molar cusp area and the base portion being provided on the distal cusp area and being substantially free of structure thereon.

### BRIEF DESCRIPTION OF THE DRAWING FIGURES

FIG. 1a is a front elevation view of a bondable molar tube according to the invention.

FIG. 1b is a rear elevation view thereof.

FIG. 1c is a top plan view thereof.

FIG. 2a is a front elevation view of a molar with the bondable molar tube attached thereon.

FIG. 2b is a top plan view of the molar with the bondable molar tube attached thereon.

FIG. 3 is a top plan view of the teeth as arranged in the inside of a mouth, showing bondable molar tubes in an arrangement with an archwire and brackets.

FIG. 4 is an alternate embodiment of a bondable molar tube according to the invention.

FIG. 5 is a perspective view of another embodiment of a bondable molar tube according to the invention, looking at the molar tube from the left side.

FIG. 6 is a rear perspective view of the molar tube of FIG. 5, looking at the molar tube from the bottom.

FIG. 7 is a bottom plan view of the molar tube of FIG. 5.

FIG. 8 is a perspective view of the molar tube of FIG. 5, as viewed from the right side and shown in an orientation that is upside down, relative to the view in FIG. 5.

FIG. 9 is a perspective view of another embodiment of a bondable molar tube according to the invention, looking at the molar tube from the left side.

FIG. 10 is a rear perspective view of the molar tube of FIG. 9, looking at the molar tube from the bottom.

FIG. 11 is a top plan view of the molar tube of FIG. 9.

FIG. 12 is a right side elevation view of the molar tube of FIG. 9.

FIG. 13 is a left side elevation view of the molar tube of FIG. 9.

### DETAILED DESCRIPTION OF THE PREFERRED EMBODIMENT

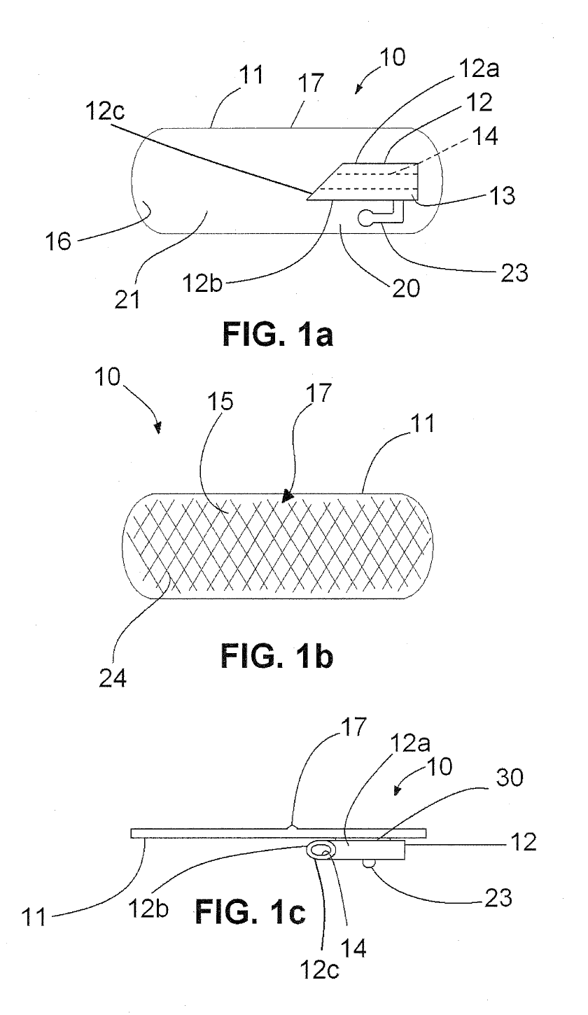

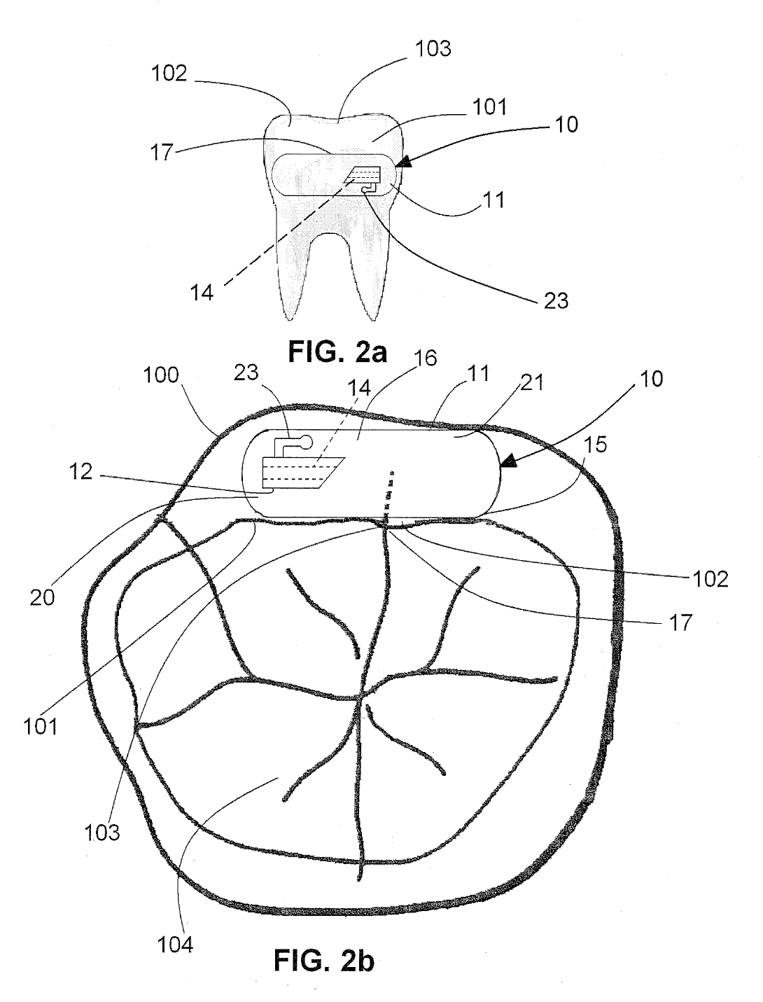

Referring to FIG. 1 an improved bondable molar tube 10 is shown having a base 11 and a tube structure 12 supported on the base 11. The tube structure 12 preferably includes an exterior surface 13 and an interior bore 14. The interior bore 14 is configured to receive an archwire therethrough and the archwire may be slid through the bore 14 for positioning at a desired length. The base 11 preferably has an attachment surface 15 and a front surface 16. The attachment surface 15 preferably comprises a textured surface for facilitating attachment of the molar tube 10 to a tooth. Suitable adhesives that are commercially available may be used for attaching the molar tube 10 to a tooth surface. The base 11 preferably may be configured with a shape that matches the contour of a molar, such as, for example, the molar 100 shown in FIGS. 2a and 2b, which is illustrated as a first maxillary molar. According to a preferred configuration, the base 11 preferably has a first following portion 20 that follows the first or mesial cusp 101 of the molar 100 (FIG. 2b) and a second or distal following portion 21 that follows the second molar cusp 102. A boss 17 preferably may be provided on the base 11 to provide a centering location for positioning of the tube 10 on the molar 100 by locating the base 11 so that the boss 17 is aligned with the buccal groove 103 of the molar 100.

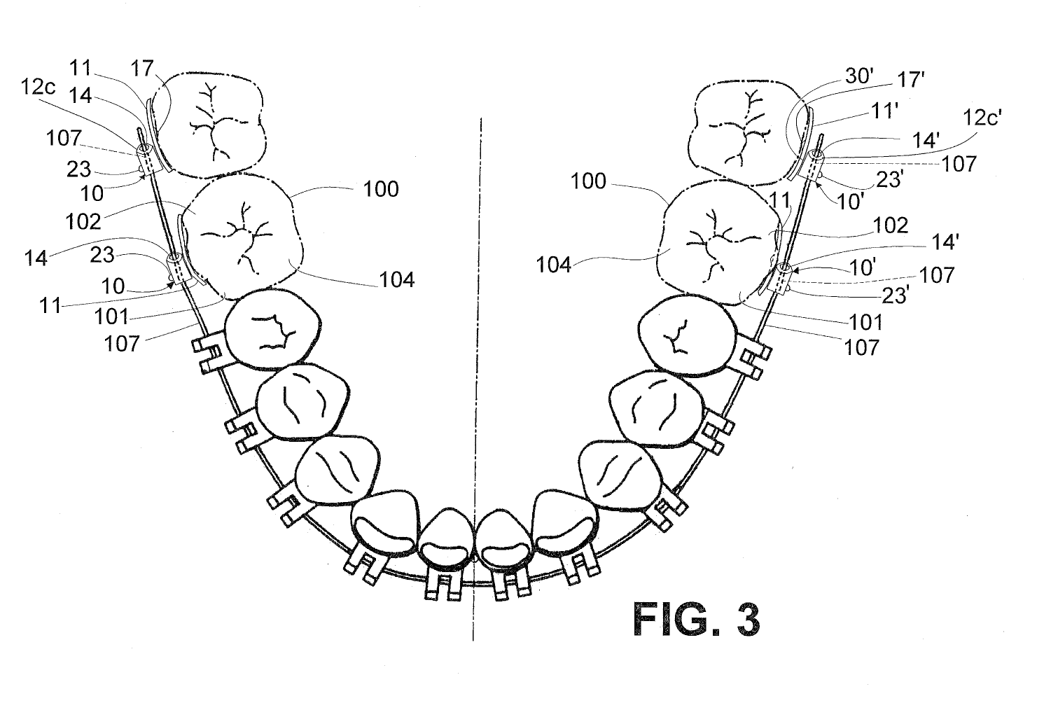

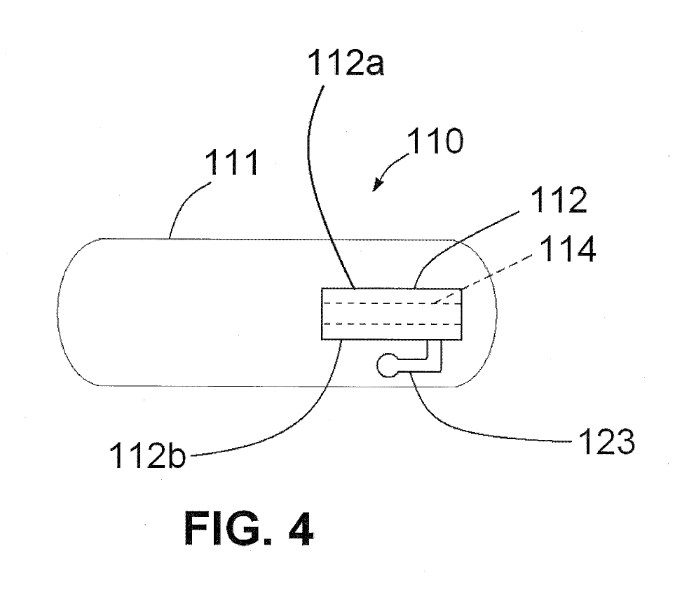

According to the preferred embodiment, the molar tube 10 provides a base 11 that is provided to adhere to the first molar cusp 101 and second molar cusp 102 of the molar 100. The tube structure 12 is mesially located and is provided on the portion of the base 11 that is mesially located on the first or mesial cusp 101. According to the preferred embodiment, the mesially disposed tube structure 12 provides an area on the base 11, at the distal cusp 102 that preferably is free of the tube or other structure that may be otherwise interfered with by the surrounding teeth, such as, for example an upper molar. The tube structure 12, according to a preferred embodiment, is angled having the tube structure edge 12a that is closest to the upper surface 104 of the molar 100 substantially shorter than the tube structure edge 12b that is closer to the gum line or root 105 of the molar 100. As shown in FIG. 3, an archwire 107 is illustrated passing through the tube structure 12 and is turned or bent at the distal end 12c of the tube structure 12. In FIG. 3, the usage of prime reference numerals is made to designate molar tubes 10′ (and their respective referenced items also appearing with a prime reference numeral) that have an orientation that is a mirror image of the molar tube 10. As shown in FIG. 3, the tube structure 12 has a dimension at its gingival length that is relatively longer than the tube dimension closest to the occlusal surface.

Preferably, the molar tube 10 includes a hook 23 that is provided thereon. The hook 23 is shown according to a preferred configuration attached to the tube structure 12 at the lower edge 12b thereof. The hook 23 is illustrated facing distally to retain a component thereon, such as, for example, a band (not shown).

According to a preferred embodiment, the molar tube structure 12 is attached to the base 11 by way of a connecting portion 30. The connecting portion 30, tube structure 12 and base 11 are shown connected together and according to a preferred construction, may be integrally formed. The connecting portion 30 may be provided in a number of configurations to orient the angle of the tube structure 12 relative to the base 11. For example, the connecting portion 30 may attach the tube structure 12 to the base 11 so that the tube structure 12 is parallel to the base 11. Alternately, the connecting portion 30 may be angled so that the tube structure 12 is angularly positioned relative to the base 11. The molar tube 10 may be provided in different configurations, so that a desired angle between a tube structure 12 and base 11 may be selected by the treating orthodontist as needed for the patient. For example, tube structure 12 may be tilted or angled to provide a tip and torque for an archwire, such as, for example, the archwire 107 shown in FIG. 3, that passes through the interior bore 14 of the tube structure 12. The tip and torque of the tube structure 12 preferably is accomplished relative to the base 11. Angulation of the tube structure 12 relative to the base 11 may be done to provide a tube structure 12 that directs an archwire to an angular position relative to the lingual surface of the base 11. In addition, the tube structure 12 may be tipped from the horizontal plane, gingivally, and the angle may be tipped upwardly or downwardly relative to the horizontal plane of the base 11. Alternately, or in addition thereto, another way to provide tip and torque is to provide an angular interior dimension for the tube structure bore 14, so that the inner bore 14 is designed with a sloped or angled surface and the archwire is directed according to the slope or angle of the interior surface within the bore 14.

According to an alternate configuration, the improved molar tube 110 is provided having a tube structure 112 on a base 111, where the tube structure edges 112a, 112b are substantially similar in their mesio-distal length. The alternate molar tube 110 preferably has a hook 123 thereon.

Preferably, the rear surface 24 of the base 11 has a bossed surface to improve adhesion to the tooth surface, such as the molar 100, when using an adhesive to attach the tube 10 to the molar 100.

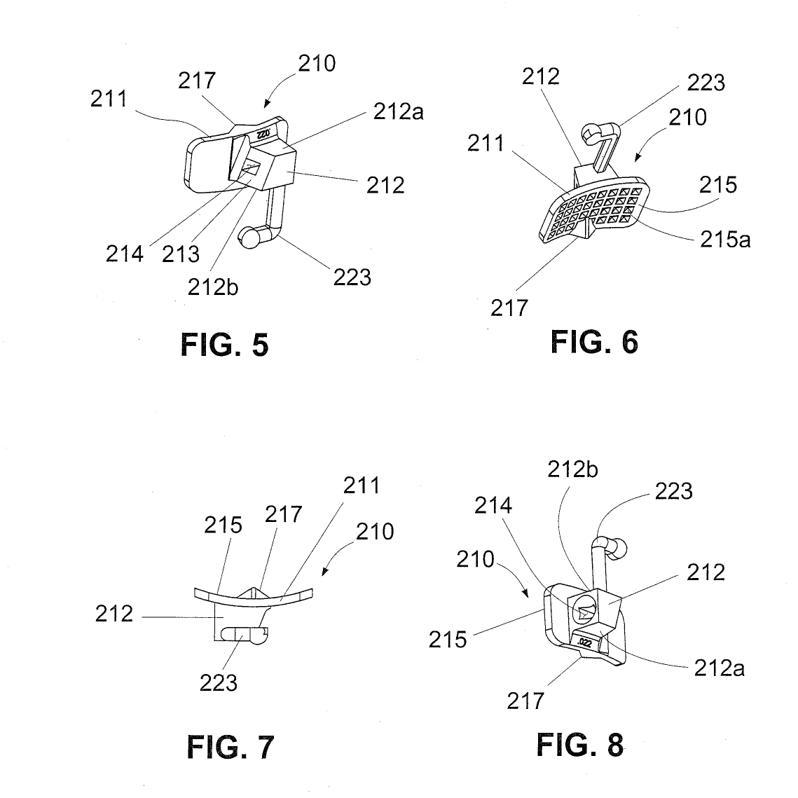

Another embodiment of the invention is illustrated in FIGS. 5-8, wherein reference numerals similar to those reference numerals of FIGS. 1a, 1b, 1c, 2a, 2b, and 3 are used but with a 200 series designation. The molar tube 210 may be used in the manner as shown and described herein in connection with the molar tube 10, by adhesively attaching the molar tube 210 to the surface of a molar tooth. Referring to FIGS. 5-8, a molar tube 210 is shown with a base 211, a tube structure 212 having an exterior surface 213 and an interior bore 214, and a hook 223. An attachment surface 215 is provided and preferably has a plurality of grooves, indentations or bosses, such as, for example, the grooves 215a, for facilitating attachment to a tooth, which generally is done using an adhesive. A locating boss 217 preferably may be provided on the base 211 to provide a centering location for positioning of the tube 10 on the molar 100 by locating the base 211 so that the locating boss 217 is aligned with the buccal groove 103 of the molar 100 (see, e.g., FIGS. 2b and 3, where the molar tube 10 is shown with the locating boss 17 aligning with the buccal groove 103).

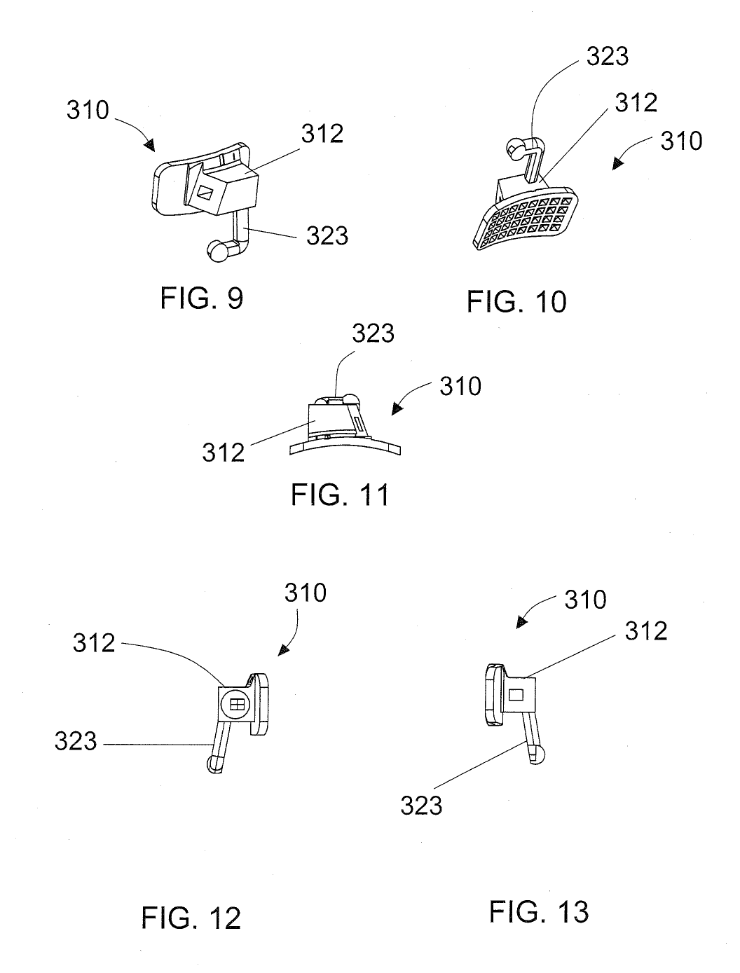

Referring to FIGS. 9-13, an alternative embodiment of a tube 310 is illustrated having a hook 323 that is angled outwardly from the tube structure 312.

While the invention is described with particular embodiments, alternate embodiments may be made within the spirit and scope of the invention as disclosed. The molar tubes 10, 10′, 110, 210 and 310 shown and described may be constructed and provided in different sizes so as to accommodate the patient, for example, providing smaller sizes for children and larger sizes for adults. In addition, orientations of the molar tubes may be provided as required for use on upper, lower, left or right molars. These and other advantages may be obtained through the use of the inventive apparatus and methods disclosed herein. Various modifications and changes may occur to those skilled in the art without departing from the spirit and scope of the invention described herein and as defined by the appended claims.

What is claimed is:

1. An improved bondable molar tube comprising:
a base,
a tube structure, supported on the base;
wherein said base is configured for attachment to a mesial cusp and a distal cusp of a molar; and
wherein said tube structure is provided in the location of said mesial molar cusp and wherein said base portion that is provided on said distal cusp is substantially free of structure thereon.

2. The tube of claim 1, having a slanted configuration at at least one mesio-distal end thereof.

3. The tube of claim 1, wherein said tube structure includes a bore disposed therein extending through said tube structure, and wherein said tube structure has a dimension at its gingival length that is relatively longer than the tube dimension closest to the occlusal surface.

4. The tube of claim 3, including a connecting portion that connects said tube structure with said base.

5. The tube of claim 1 including a lingual boss for locating and positioning the bondable molar tube on a tooth.

6. The tube of claim 1, including a hook.

7. The tube of claim 1, wherein said base has a mesial portion and a distal portion, and wherein said tube structure is provided on said mesial portion.

8. The tube of claim 6, wherein the hook is angularly positioned relative to the tube structure to extend outwardly therefrom.

9. An improved bondable molar tube comprising:
a base having a first side and a second side, wherein said second side comprises a mounting side with a textured surface for promoting an adhesive bond of said molar tube to a tooth,
a tube structure supported on the base, said tube structure having a mesio-distal end thereof with a slanted configuration, said tube structure including a bore disposed therein extending through said tube structure, and wherein said tube structure has a gingival length and a body portion, said body portion having a first tube structure edge and a second tube structure edge, wherein said first tube structure edge is substantially shorter than the second tube structure edge to provide said tube structure with a dimension at its gingival length that is relatively longer on one edge of said tube;
a lingual boss for locating and positioning the bondable molar tube on a tooth, said lingual boss extending from said base on said mounting side of said base; and
a hook;
wherein said base has a mesial portion and a distal portion for attachment to a respective mesial cusp and a distal cusp of a molar; and
wherein said tube structure is provided in the location of said mesial base portion to correspond with an attachment location at said mesial molar cusp, and wherein said distal base portion that is provided to correspond with an attachment location at said distal molar cusp is substantially free of structure thereon.

10. A method for treatment of an orthodontic condition, including:
attaching the improved bondable molar tube of claim 9 to a molar having a mesial cusp and a distal cusp by:
applying adhesive to the second side of said base of the improved bondable molar tube; and
positioning the improved bondable molar tube on said molar so that the tube structure is located substantially on said molar mesial molar cusp.
